(19) United States
(12) Patent Application Publication
(10) Pub. No.: US 2019/0084246 A1
(43) Pub. Date: Mar. 21, 2019

(54) ARRANGEMENT INCLUDING A POSITIONING DEVICE AN AN OBJECT TO BE GLUED TO A SURFACE AND METHOD FOR ATTACHMENT

(71) Applicant: SFS intec Holding AG, Heerbrugg (CH)

(72) Inventor: Gabriel Procopiescu, Sindelfingen (DE)

(73) Assignee: SFS intec Holding AG, Heerbrugg (CH)

(21) Appl. No.: 16/195,007

(22) Filed: Nov. 19, 2018

Related U.S. Application Data
(62) Division of application No. 14/903,439, filed on Jan. 7, 2016.

(30) Foreign Application Priority Data
Jul. 10, 2013 (DE) 102013011536.1

(51) Int. Cl. B29C 65/48; F16B 5/06; F16B 21/07; F16B 11/00; B29C 65/56; F16B 9/02; B29L 31/30

(52) U.S. Cl. CPC B29C 65/48; F16B 5/0642; F16B 21/073; B29L 2031/3076; B29C 65/56; F16B 9/02; F16B 11/006

(57) ABSTRACT

An arrangement including a plate to be glued to a target surface, and a positioning device for positioning the plate which is to be glued onto the target surface. The positioning device has an attachment for temporarily or permanently attaching the positioning device to the target surface and an internal surface. The internal surface forms a guide for the plate that defines a pre-mounting position and a final mounting position of the plate. The plate can be moved relative to the internal surface and as a result can be transferred from the pre-mounting position to the final mounting position. The internal surface is configured to enter at least partially into immediate, positively-locking contact with the plate in order to guide the object. A method for gluing an object onto a target surface is also provided.

### INCORPORATION BY REFERENCE

The following documents are incorporated herein by reference as if fully set forth: U.S. application Ser. No. 14/903,439, filed Jan. 7, 2016.

### BACKGROUND

The present invention relates to a positioning device for positioning an object to be glued to a surface. The invention also relates to an arrangement comprising a positioning device of this type and an object to be glued. The invention further relates to a method for gluing an object to a surface.

It is known to use a positioning device to fix an object to be glued to a surface, for example a carrier element or support element or any other structural component, in place on the surface (also referred to in the following as the target surface) while the adhesive cures. For this purpose, the positioning device is first secured, for example stuck, to the surface, it being sufficient for this purpose to secure the device in a less durable and stable manner than is desired for securing the object to the target surface. Next or even beforehand, the object to be glued is mechanically coupled to the positioning device, for example inserted or clamped in the positioning device. Adhesive is applied to either a bonding surface of the object or a bonding surface of the target surface and the positioning device is activated to position the object relative to the target surface in such a way that the adhesive bonds the object to the target surface. In the following, this position of the object will also be referred to as the final mounting position. A different position that the object assumes beforehand, in which the object is at a distance from the target surface such that no adhesive bond can be produced between the object and the target surface, is also referred to as the pre-mounting position. Both the pre-mounting position and the final mounting position are defined relative to the positioning device. When the positioning device is positioned on the target surface, the two positions can also be defined relative to the target surface. When the object is in the pre-mounting position, it may be advantageous to apply the adhesive to the object or to the target surface, preferably prior to the positioning device being secured to the target surface.

U.S. Pat. No. 7,294,385 B1 discloses a device for securing an object to a substrate. The device comprises an outer support element which is temporarily adhered to the substrate. The device further comprises an inner mount, into which the element to be glued is inserted. The inner mount can move relative to the outer support element. An inner surface of the outer support element and an outer surface of the inner mount are adapted to each other and act as a guide for the inner mount and thus for the element to be glued. The guide defines a pre-mounting position and a final mounting position for the inner mount.

### SUMMARY

The object of the invention is to disclose a positioning device that has a simple construction and entails low material costs. The object of the invention is also to disclose a method for gluing an object to a target surface, which method can be implemented using a positioning device that has a simple construction and low material costs. These objects are achieved by the features of the independent claims.

The positioning device comprises attachment means for temporarily or permanently attaching the positioning device to the target surface, and an inner surface which forms a guide for the object. The object can, for example, be a retainer intended to be glued in a passenger compartment of an aircraft, for example to a support structure of the aircraft. Retainers of this type can be used, for example, to secure electric cables or cable clamps in the aircraft. The guide defines a pre-mounting position and a final mounting position of the object. The object can be displaced relative to the inner surface and thus can be moved from the pre-mounting position into the final mounting position.

In order to guide object, the inner surface is designed to come into direct interlocking contact with the object at least in part. At least some parts of the inner surface are thus at least temporarily in direct contact with the object and define the pre-mounting position and final mounting position thereof. A movable mount for the object can thus be omitted.

According to an advantageous embodiment, the shape of the inner surface for guiding the object is adapted to the external shape of the object. For example, the inner surface of the positioning device can comprise protrusions or recesses which each engage at least temporarily with complementary elements of the external shape of the object, for example only in the pre-mounting position or only in the final mounting position. Alternatively or additionally, however, the inner surface can also have a universal nature and be suitable for a plurality of different objects. For example, the inner surface can be flexible in order to adjust, to a certain degree, to the external shape of different objects.

Since there is no need for a movable mount, the positioning device can be in a single piece, i.e. produced without parts which can move or pivot relative to one another. The device can thus be produced in a particularly simple manner, for example as a single-piece moulded part made of a suitable plastics material.

According to an embodiment, the positioning device is resilient at least in part in order to allow the object to move from the pre-mounting position into the final mounting position by exerting a force on the object. When the positioning device is not deformed or is only slightly deformed, the inner surface can, for example, form a forwards catch which prevents the object from moving from the pre-mounting position into the final mounting position. By exerting an appropriate force, the positioning device can be resiliently deformed in such a way that the object overcomes the forwards catch and passes into the final mounting position. A backwards catch can also be provided, which prevents the object from moving backwards into the pre-mounting position. When passing from the pre-mounting position into the final mounting position, plastic deformations can also occur on the positioning device and/or the object. Depending on the design of the positioning device and/or of the object, plastic deformations can be intentional, for example to aid locking of the object in a desired position. In any case, it must be ensured that the object cannot easily leave the final mounting position.

According to another embodiment, the positioning device comprises a movable element which allows the inner surface to expand and the object to move from the pre-mounting position into the final mounting position by exerting a force on the object. A movable element of this type may be particularly advantageous if the positioning device is not sufficiently resilient to allow the object to move from the pre-mounting position into the final mounting position as a result of plastic deformation of the positioning device.

The inner surface can comprise at least one first protrusion which is designed to come into direct interlocking contact with the object at least in part, in order to cause the object to be locked in the pre-mounting position or to assist this locking. The protrusion can in particular assist in preventing the object from moving backwards, i.e. a movement which moves the object away from the final mounting position. It is possible to provide a plurality of such protrusions, for example two, three, four or more, which together provide the desired locking action.

Furthermore, the inner surface can comprise at least one second protrusion which is designed to come into direct interlocking contact with the object at least in part, in order to cause the object to be locked in the final mounting position or to assist this locking. The one or more protrusions, for example two, three, four or more second protrusions, in particular either help to prevent or prevent the object from moving backwards out of the final mounting position. According to a particularly advantageous embodiment, said protrusions also act as a forwards catch when the object is in the pre-mounting position.

The first protrusion or the second protrusion or both protrusions can, for example, be formed as snap-in hooks. A snap-in hook is a component or in this case a surface feature which allows a complementary element to the snap-in hook to slide along the snap-in hook, and prevents a movement in the opposite direction as soon as a “snap-in point” or “point of no return” has been passed. For example, a snap-in hook can be designed as an asymmetric lug.

The second protrusion can comprise a holding surface which is at an angle relative to the target surface and pushes the object towards the target surface in the final mounting position. It is thus possible to generate a suitable contact pressure that pushes the object and the target surface together and thus promotes the formation of an adhesive bond between the object and the substrate.

According to an embodiment, the first and/or the second protrusion are arranged on a movable element of the positioning device. In particular, the element can be a pivotable element. By moving, for example pivoting, the movable element, the forward blocking action of the first or second protrusion can be overcome in order to move the object into the pre-mounting position and further into the final mounting position.

The object can comprise a plate which can be glued to the target surface.

An adhesive, by means of which the plate can be bonded to the target surface, can be applied at least to a part of the glueable plate.

The object can in particular be a retainer that comprises means for securing components in an aircraft, for example for securing internal cladding elements.

The target surface can in particular be a surface of a structure in an aircraft.

The method according to the invention for gluing an object to a target surface is carried out using a positioning device that comprises an inner surface which forms a guide for the object, the guide defining a pre-mounting position and a final mounting position of the object. The method comprises at least the following steps: applying adhesive to a gluing region of the target surface or to a gluing region of the object while the object is in the pre-mounting position; securing the positioning device to the target surface; moving the object from the pre-mounting position into the final mounting position by displacing the object relative to the inner surface, the inner surface coming into direct interlocking contact with the object at least in part; and curing the adhesive. The object is thus moved directly along the inner surface of the positioning device secured to the target surface. There is no need for a retaining device which is movable relative to the inner surface for retaining the object. The above method steps do not necessarily have to be carried out in the stated order. In particular, the adhesive can be applied at any time prior to the movement into the final mounting position.

The positioning device can be removed once the adhesive has cured. Alternatively, however, it may also be advantageous to leave the positioning device on the target surface. On one hand, this eliminates the work of the removal and, on the other hand, depending on its design, the positioning device can have a certain mechanical protective action for the adhesive joint, for example in the manner of a shield.

### BRIEF DESCRIPTION OF THE DRAWINGS

The invention will be described in more detail below on the basis of embodiments and with reference to the accompanying drawings. In the process, like reference numerals denote like or similar components.

In the drawings:

FIG. 1 is a cross section through a positioning device;

FIG. 2 is a view of a detail of FIG. 1;

FIG. 3 is a plan view of the positioning device;

FIG. 4 is a cross section through the positioning device;

FIG. 5 is a view of a detail of FIG. 4;

FIG. 6 is a plan view of the positioning device;

FIG. 7 is a perspective view of the positioning device;

FIG. 8 is a perspective view of the positioning device together with an object to be positioned;

FIG. 9 is a cross section through a part of a positioning device according to another example, in the pre-mounting position;

FIG. 10 is a cross section through a part of the positioning device of FIG. 9 in the final mounting position;

FIG. 11 is a perspective view of a part of the positioning device of FIGS. 9 and 10;

FIG. 12 is a cross section through a part of a positioning device according to another example, in the pre-mounting position;

FIG. 13 is a cross section through a part of the positioning device of FIG. 12 in the final mounting position;

FIG. 14 is a perspective view of a part of an object to be positioned;

FIG. 15 is a perspective view of a part of the positioning device of FIGS. 12 and 13;

FIG. 16 is a cross section through a part of the positioning device according to another example, in the pre-mounting position;

FIG. 17 is a cross section through a part of the positioning device of FIG. 16 in the final mounting position;

FIG. 18 is a partial perspective view of the positioning device of FIGS. 16 and 17;

FIG. 19 is a cross section through a part of the positioning device according to another example, in the pre-mounting position;

FIG. 20 is a cross section through a part of the positioning device of FIG. 19 in the final mounting position;

FIG. 21 is a partial perspective view of the positioning device of FIGS. 19 and 20;

FIG. 22 is a partial perspective view of the object which is positioned using the positioning device of FIGS. 19 to 22;

FIG. 23 is a partial sectional view of a positioning device together with an object;

FIG. 24 is a partial sectional view of an example positioning device together with an object;

FIG. 25 is a partial sectional view of an example positioning device together with an object;

FIG. 26 is a partial perspective view of an example of an object to be glued.

### DETAILED DESCRIPTION OF THE PREFERRED EMBODIMENTS

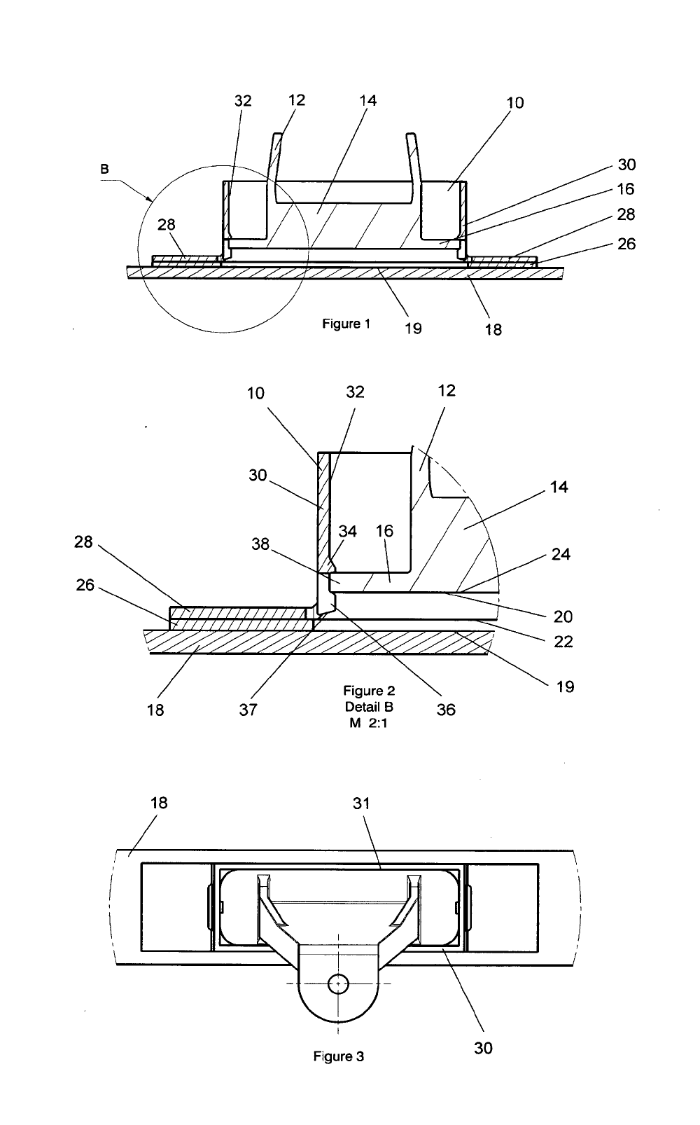

FIGS. 1 to 6 are various views of an example of a first embodiment of a positioning device 10 and of an arrangement comprising an object 12 to be glued to a target surface 19, in different mounting positions. The object 12 can be a retainer to be glued in an aircraft, for example. In the example shown, the target surface 19 is a surface of a carrier or substrate 18. The substrate 18 can be a covering wall or a side wall of an aircraft, for example. In the example shown, the target surface 19 is planar, although the invention described here can also be applied to non-planar target surfaces (not shown).

For example, the object 12 comprises a base 14 and a main plate 16. The object 12 comprises a surface 24 which is intended to be glued to the surface 19 of the substrate 18. In the example shown here, this is achieved by applying an adhesive layer 20, which for example is formed by liquid adhesive which cures following application. The adhesive layer 20 can be applied to the target surface prior to the object 12 being secured. Alternatively or additionally, an adhesive layer can be applied to the surface 24 of the object 12 before the object 12 is secured (not shown). In the example shown, the surface 24 is the underside of the plate 16.

The positioning device 10 comprises securing means 26, 28 which allow the positioning device 12 to be temporarily or permanently secured to the target surface 19. In the example shown, the securing means are formed by two plates 28 of the positioning device 10, for example by side plates which are secured to the target surface 19 by means of adhesive strips 26. The adhesive strips 26 are preferably attached to the positioning device 10 (to the side plates 28 in the example shown) when the positioning device 10 is in a delivery state. Alternatively, however, the adhesive strips 26 can also be applied to the target surface 19 before the positioning device 10 is placed thereon. In this case, the adhesive strips 26 are also used for marking the intended position for the positioning device on the target surface 19. In another example, the securing means comprise a magnet apparatus. The magnet apparatus can be formed by permanent magnets or electromagnets. The use of electromagnets allows the positioning device 12 to be detached from the substrate 18 in a simple manner by switching off the electromagnets. However, in order to use magnets, the substrate 18 has to be either ferromagnetic at least at some points or rigidly connected to a ferromagnetic material. In many cases in practice, the substrate 18 is not ferromagnetic.

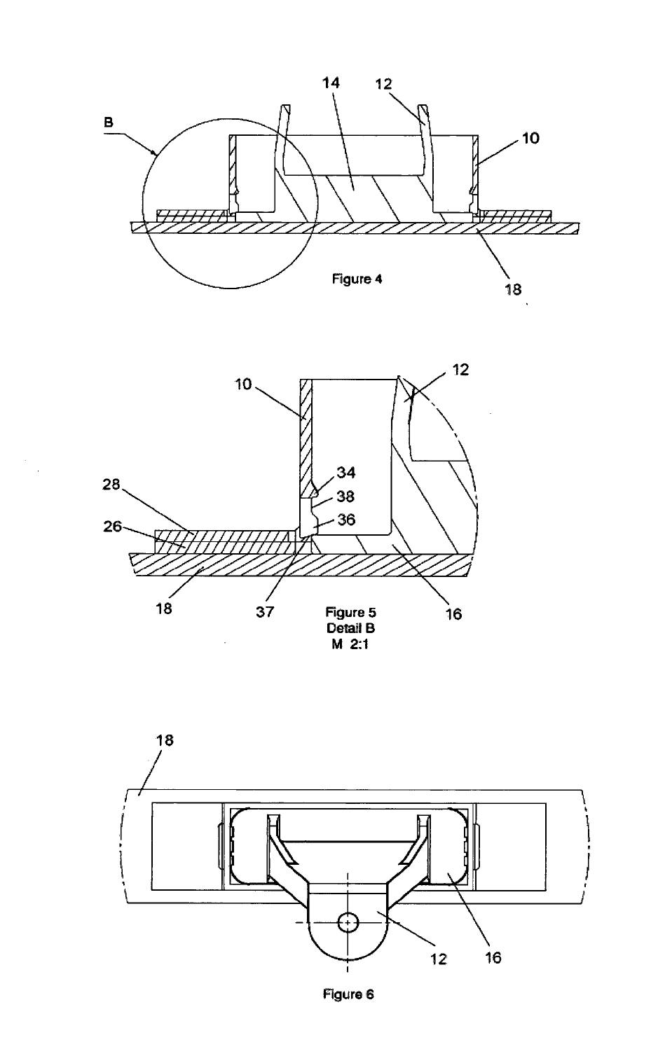

The positioning device 12 comprises an inner surface 32 which defines a guide path for the object 12. In the example shown, the inner surface 32 is the inner surface of a wall 30, which can for example be designed as a frame 31 which surrounds at least part of the object 12. The inner surface is not necessarily one continuous surface, but rather can be assembled from separate surface portions. The guide path for the object 12, as defined by the inner surface, has a pre-mounting position (see FIGS. 1 to 3) and a final mounting position (see FIGS. 4 to 6). The object 12 is displaceable on the guide path relative to the inner surface 32 and can thus be moved from the pre-mounting position into the final mounting position. The guide path described here is not a physical component, but rather a series of permitted positions (points) of the object 12 relative to the inner surface 32.

The object is guided by the inner surface coming into direct interlocking contact with the object 12 at least in part. The inner surface 32 thus restricts the mobility of the object 12 and only allows the object 12 to move along the guide path. In the examples shown, the guide path only has two firm positions for the object 12, i.e. the pre-mounting position (see for example FIGS. 1 to 3) and the final mounting position (see for example FIGS. 4 to 6). The design of the inner surface 32 for directly guiding the object 12 is advantageous in that there is no need for a retainer that can move relative to the inner surface 32 for retaining the object 12. In the solution described here, the object 12 mechanically interacts directly with the positioning device 10 that is to be rigidly secured with respect to the substrate 18, without the need for a movable component of the positioning device 10 to move the object 12 from the pre-mounting position into the final mounting position.

In the example shown, the inner surface 32 comprises at least two first protrusions 34 and at least two second protrusions 36. The protrusions 34 and 36 define the pre-mounting position and the final mounting position of the object 12.

If the object 12 is in its pre-mounting position (see FIGS. 1 to 3), the first protrusions 34 work together as a backwards catch and thus counteract a hypothetical movement of the object 12 away from the target surface 19 (upwards in FIGS. 1 and 2). The second protrusions 36 on the other hand act as a forwards catch and thus counteract a hypothetical movement of the object 12 towards the target surface 19. In this setup in the example shown, the plate 16 of the object 12 extends in a gap 38 formed between each first protrusion 34 and an adjacent second protrusion 36. The plate 16 and also the entire object 12 are thus locked.

When the object 12 is in its final mounting position (see FIGS. 4 to 6), the first protrusions 34 no longer interact with the object 12. By contrast, the second protrusions 36 now act as a backwards catch and thus counteract a hypothetical movement of the object 12 away from the target surface 19 (upwards in FIGS. 4 and 5). In this setup, the plate 16 of the object 12 extends between the second protrusions 36 and the target surface 19 of the substrate 18 and is thus locked.

By generating a forward force between the positioning device 10 and the object 12, the object 12 can be moved from the pre-mounting position (see FIGS. 1 to 3) into the final mounting position (see FIGS. 4 to 6). In this example shown, this is achieved by taking advantage of the resilience of the wall 30. When the object 12 moves forwards (downwards in FIGS. 1, 2, 4 and 5), the wall 30 is slightly expanded or bent outwards, and so the second protrusions 36 lose their forwards blocking action. The plate 16 then snaps into the gaps formed between the second protrusions 36 and the target surface 19 and is locked thereby.

The second protrusions 36 each comprise a retaining surface 37 which is at an angle to the target surface 19. The result of the angular design is that, when in the final mounting position (see FIGS. 4 to 6), the plate 16 is pushed against the target surface 19 by the second protrusions owing to the resilience of the device 10. Alternatively, however, it is also conceivable to design the second protrusions 36 such that the retaining surface extends in parallel with the target surface and does not produce any significant contact force. It should be noted that, depending on the adhesive used, it may or may not be necessary to press together the surfaces to be glued.

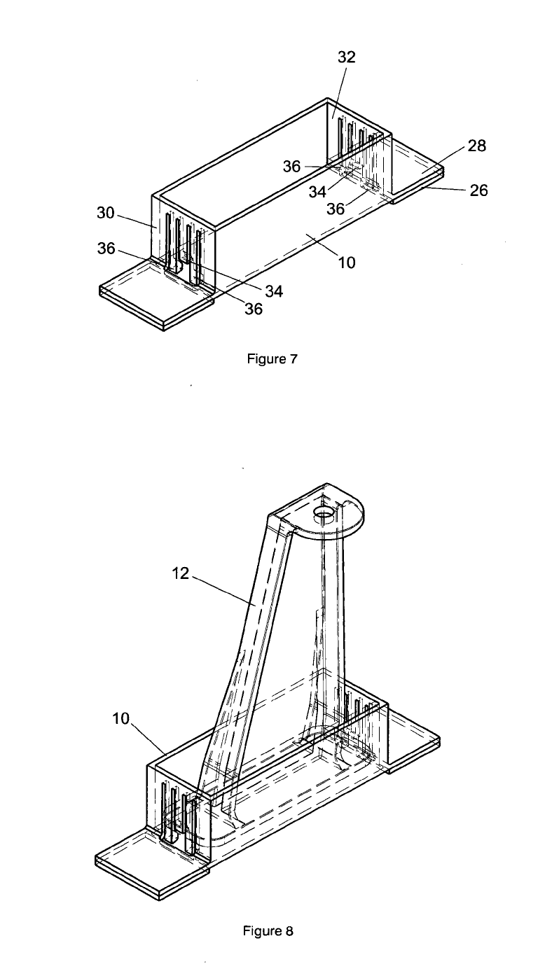

FIGS. 7 and 8 show an example of an embodiment in which the first protrusions 34 and the second protrusions 36 are each formed as clips. Two first protrusions 34 formed as clips (first clips 34) are arranged opposite one another at a first height on the inner wall 32. Four second protrusions 36 formed as clips (second clips 36) are arranged at a second height on the inner wall 32. Here, the term “height” denotes the distance from the target surface 19 (not shown in FIGS. 7 and 8). Each individual clip 34 or 36 can, for example, be formed as an elongate, resilient tab which extends substantially in parallel in the forward direction (i.e. towards the target surface) from a particular bottom point of the wall 30 and has a thickened top end. This design allows the clips to be sufficiently flexible, even when a relatively rigid material is used.

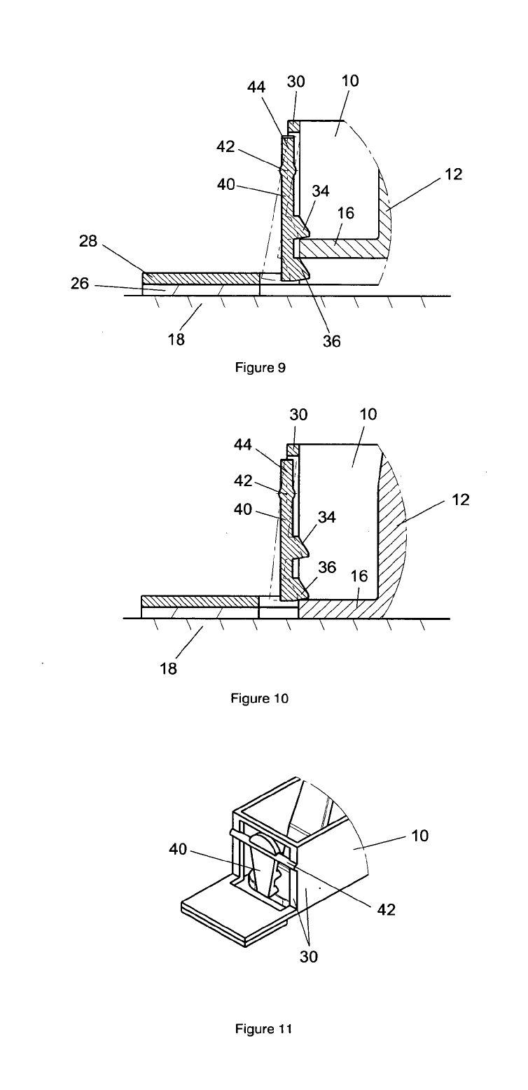

FIGS. 9 to 11 show an example of another embodiment of a positioning device 10. The wall 30 comprises a movable element 40, on which at least one first protrusion 34 and a second protrusion 36 are formed. In this example, the movable element 40 can pivot within a limited angular range about a pivot axis 42 parallel to the target surface 19. The maximum pivot angle can, for example, be between 1° and 2°, or between 2° and 5°, or between 5° and 10°. Alternatively, the movable element 40 can be formed integrally with the rest of the wall 30. In this case, the pivot axis 42 is replaced by a flexible connecting piece (not shown) which integrally joins the movable element to the rest of the wall 30.

If the object is not yet in its final mounting position, the movable object 12 is pivoted (by virtue of the plate 16 in this example) into the unlocked position (indicated by the dashed outline in FIGS. 9 and 10) by generating a forward force between the object 12 and the device 10. In the unlocked position, the protrusions 34 and 36 do not counteract a forward movement of the object 12, and so the object 12 can first be moved into the pre-mounting position (see FIG. 9) and subsequently into the final mounting position (see FIG. 10). During this forward movement, the object slides on the suitably angled sliding surfaces of the protrusions 34 or 36. In the example shown, the movable element 40 can also be unlocked, for example manually, by external actuation, namely by pressing on a lever region 44.

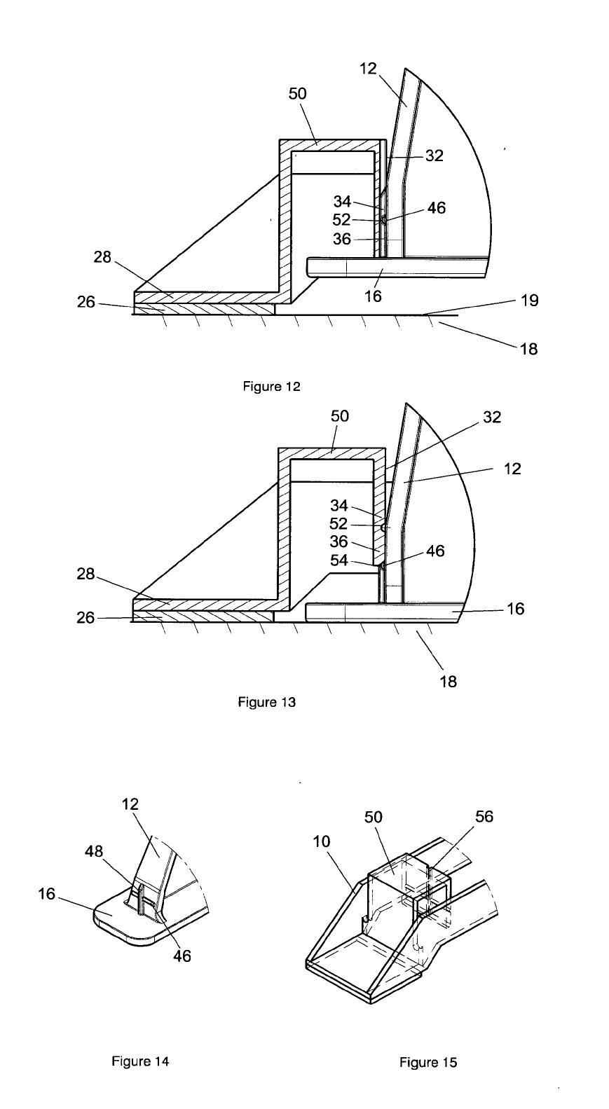

In the example shown in FIGS. 12 to 15 of another embodiment, the protrusions 34 and 36 on the inner wall 32 are no longer produced as such. The inner wall 32 comprises a first recess 52 and a second recess 54. For example, the recesses 52 and 54 can each be designed as a groove extending in parallel with the target surface 19. In the pre-mounting position (see FIG. 12), a locking element 46 of the object 12 extends into the first recess 52 and as a result locks the object 12 with respect to the device 10 and thus with respect to the target surface 19. In the final mounting position (see FIG. 13), the locking element 46 of the object 12 extends into the second recess 54 and as a result locks the object 12 with respect to the device 10 and thus with respect to the target surface 19. By exerting a forward force, the object 12 is moved from the pre-mounting position into the final mounting position. The object 12 also comprises a rail 48 (see FIG. 14) which extends perpendicularly to the target surface 19, is engaged with a complementary rail 56 (see FIG. 15) and restricts the permitted movement of the object 12 to a linear movement along the rails 48, 56. In this example, the side plate 28 of the positioning device 10 comprises a portion 50 which leads away from the target plane 19 in a U-shape (U-shaped portion). The wall 30 is formed at least in part by one of the two leg regions of the U-shaped portion 50.

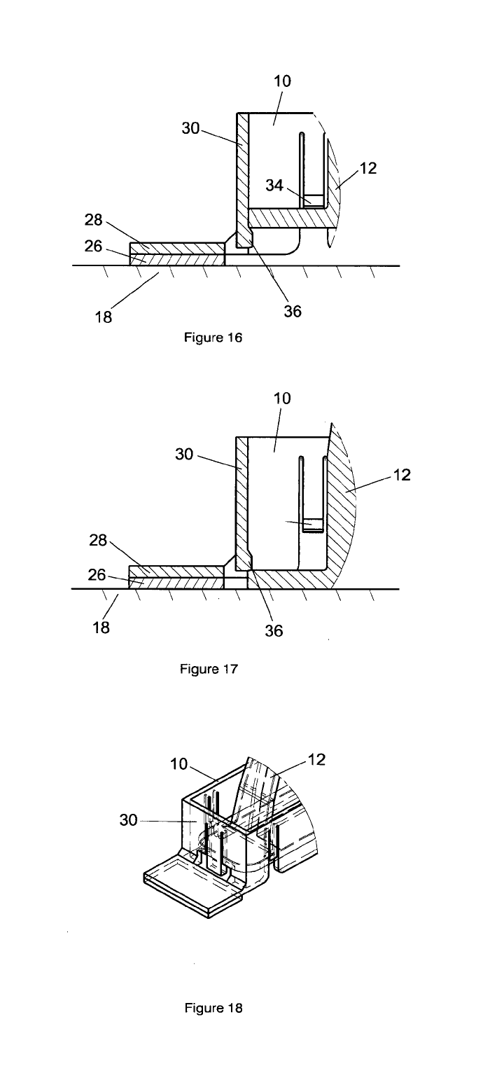

FIGS. 16 to 18 show an example of an embodiment in which the first protrusions 34 (in this example, four first protrusions 34 formed as tab heads) and the second protrusions 36 (in this example, two second protrusions 36 formed as tab heads) are arranged on portions of the inner surface 32 that have different orientations. A structure of this type can be particularly advantageous over an arrangement in which each second protrusion 36 is arranged below a first protrusion 34, since the entire height of the inner surface is thus available for an individual protrusion 34 or 36.

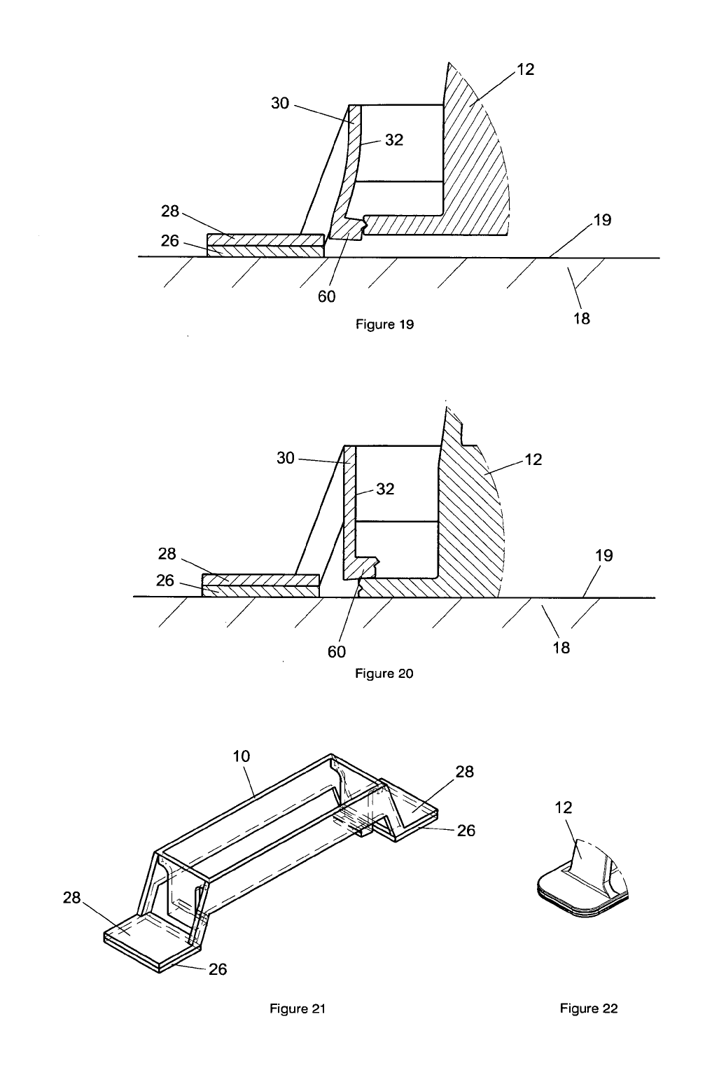

FIGS. 19 to 22 show an example of another embodiment. In this example, the wall 30 comprises a resilient, substantially L-shaped element 58, the shorter leg 60 of which is designed to lock the object 12 in the pre-mounting position. The leg 60 comprises an end face which is jagged or is provided with at least one protrusion or recess and which faces the object 12 and is engaged therewith (by means of the plate 16 in this example) while the object 12 is in its pre-mounting position (see FIG. 19). By a forward force being exerted on the object 12, the L-shaped element 58 is spread outwards, i.e. counter to the surface normal vector of the inner surface 32, in order to open the path for the object. The object can thus be moved into its final mounting position (see FIG. 20). Once the final mounting position is reached, the tension is released in the L-shaped element 60 and said element moves back into its initial position. In the process, the element acts as a backwards catch and thus locks the object 12 in the final mounting position on the substrate 18. A contact pressure is not necessarily produced in the process. This embodiment is distinguished in particular in that the object 12 is locked in the final mounting position without the wall 30 used for this purpose extending as far as the target surface. Therefore, there is a relatively low risk of the wall 30 coming into contact with adhesive applied to the target surface 19 and thus of the guidance of the object 12 being impeded. Contact of this type with the adhesive could lead to the wall 30 and thus the inner surface 32 thereof losing mobility, and so in some circumstances the object 12 may not be moved into the final mounting position.

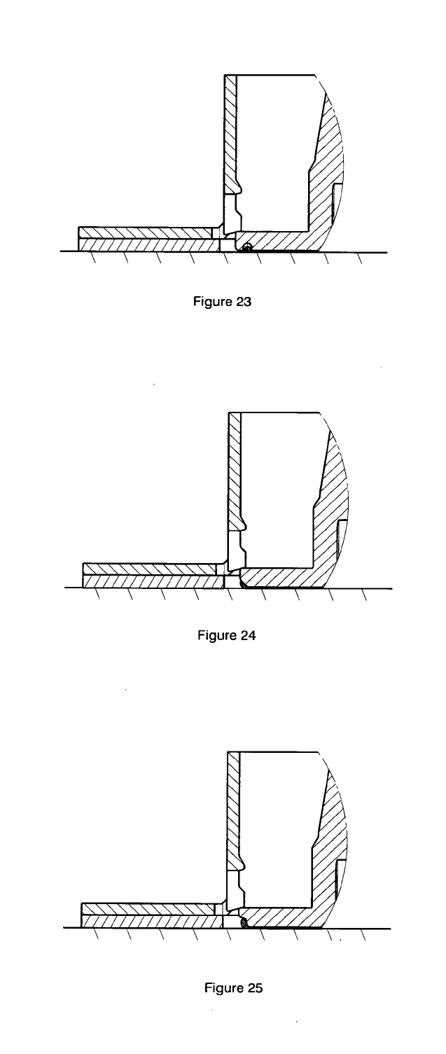

FIG. 23 shows a variant of the embodiment described with reference to FIGS. 1 to 6. In this variant, the object 12 comprises a cavity 62, for example a hole or depression, on its surface 24 to be glued. Advantageously, the cavity 62 is arranged in an edge region of the surface 24. The cavity 62 is used to collect adhesive 20 when the object is in the final mounting position, as shown. Once the final mounting position has been reached, some of the adhesive 20 can be pushed outwards between the object 12 and the target surface 19 and as a result reaches a free region of the target surface 19 that is not to be glued. By providing the cavity 62, the amount of adhesive thus released can be reduced. Therefore, the risk of adhesive accidentally reaching surfaces that are not to be glued, for example parts of the positioning device, is also reduced.

In the variant according to FIG. 24, the cavity 62 is formed in a lower edge of the object 12, for example by beveling or rounding the edge. In this case, the cavity 62 is open outwards.

FIG. 25 shows another variant. In this example, the cavity 62 for collecting adhesive 20 is a spatial region between a lug 64 of the object 12 and the target surface 19.

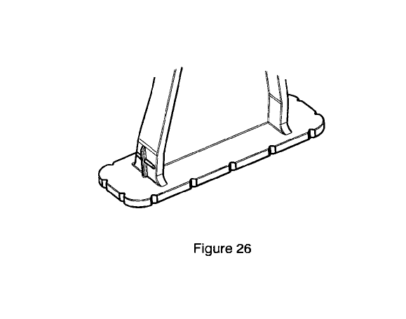

In the example shown in FIG. 26, the plate 16 of the object 12 is provided, on its outer periphery or at least on portions of its outer periphery, with adhesive guides 66 that extend perpendicularly to the target surface 19. As a result, a capillary effect can be produced on the adhesive. Depending on the viscosity of the adhesive, excess adhesive is thus guided away upwards, i.e. away from the target surface. For example, the adhesive guides 66 can be formed as grooves, flutes or channels. Said guides should be narrow by comparison with the outer circumference of the plate 16. Advantageously, they each comprise an inner edge that is as sharp as possible.

Wherever used, spatial information such as up, down, above, below, right, left, etc. is to be understood as information which merely describes the arrangement of elements relative to one another. The term “a plurality” means “at least two”.

The features of the invention disclosed in the above description, in the drawings and in the claims can be essential to the implementation of the invention both in isolation and in any given combination.

### LIST OF REFERENCE NUMERALS

10 Positioning device
12 Object
14 Base
16 Plate
18 Substrate
19 Target surface
20 Adhesive
22 Surface
24 Surface
26 Adhesive strips
28 Plate
30 Wall
31 Frame
32 Inner surface
34 First protrusion
36 Second protrusion
37 Retaining surface
38 Gap
40 Movable element
42 Pivot axis
44 Lever region
46 Locking element
48 Rail
50 U-shaped portion
52 First recess
54 Second recess
56 Rail
58 L-shaped element
60 Leg
62 Cavity
64 Lug
66 Adhesive guide

1. An arrangement (10, 12) comprising:
an object including a plate (16) to be glued to a target surface (19);
a positioning device (10) that positions and holds the plate to the target surface, the positioning device including:
side plates and adhesive strips configured to temporarily or permanently secure the positioning device to the target surface (19);
an inner surface (32) forming a guide to the plate, the inner surface configured to define a pre-mounting position and a final mounting position of the plate, and configured to displace and move the plate from the pre-mounting position into the final mounting position; and
the inner surface (32) is configured to come into a direct interlocking contact with the plate (12) that is to be mounted to the target surface.

2. The arrangement according to claim 1, wherein a shape of the inner surface (32) is adapted to an external shape of the plate (162).

3. The arrangement according to claim 1, wherein the positioning device is a single piece.

4. The arrangement according to claim 1, further comprising a resilience wall to allow the object (12) to be moved from the pre-mounting position into the final mounting position when exerting a force on the plate (16).

5. The arrangement according to claim 1, further comprising at least one movable element (40) configured to expand the inner surface and move the plate from the pre-mounting position into the final mounting position by exerting a force on the plate.

6. The arrangement according to claim 1, wherein the inner surface (32) comprises at least one first protrusion (34) configured to assist and lock the plate in the pre-mounting position.

7. The arrangement according to claim 6, wherein the inner surface (32) comprises at least one second protrusion (36) located closer to a level of the securing plates than the at least one first protrusion and configured to assist and lock the object in the final mounting position.

8. The arrangement according to claim 7, wherein the at least one first protrusion (34) or the second at least one protrusion (36) or both protrusions are formed as snap-in hooks.

9. The arrangement according to claim 7, wherein the at least one second protrusion (36) comprises a retaining surface positioned at an angle to the target surface and configured to push the plate (16) towards a target surface (19) when the plate (16) is in the final mounting position.

10. The arrangement according to claim 7, wherein the at least one first or the at least one second protrusion (36, 38) or both are arranged on a movable element (40) of the positioning device.

11. The arrangement according to claim 1, wherein an adhesive (20) is applied at least to a part of the plate (16).

12. The arrangement according to claim 1, wherein the plate (16) is a retainer for securing components in an aircraft.

13. The arrangement according to claim 1, wherein the target surface (19) is a surface of a structure in an aircraft.

14. A method for gluing an object (12) to a target surface (19) using a positioning device (10), the positioning device comprises an inner surface (32) which forms a guide for the object (12) and the guide defines a pre-mounting position and a final mounting position of the object, comprising the following steps:
applying adhesive (20) to a gluing region of the target surface (19) or to a gluing region of the object (12) while the object (12) is in the pre-mounting position;
positioning the positioning device (10) on the target surface (19) and securing the positioning device (10) thereto while the object (12) is in the pre-mounting position;
moving the object (12) from the pre-mounting position into the final mounting position by displacing the object relative to the inner surface (32), wherein the inner surface (32) comes into direct interlocking contact with the object (12) at least in part; and
curing the adhesive.

15. The method according to claim 14, further comprising the step of:
removing the positioning device once the adhesive is cured.

16. The method according to claim 14, wherein the object (12) is a plate.
